(19) United States
(12) Patent Application Publication
(10) Pub. No.: US 2025/0132106 A1
(43) Pub. Date: Apr. 24, 2025

(54) TRIGGER SWITCH

(71) Applicant: OMRON Corporation, KYOTO (JP)

(72) Inventors: Takumi FUJIHARA, Kyoto-shi (JP); Yohei TSUKANAKA, Kyoto-shi (JP); Kazushi MAETA, Kyoto-shi (JP); Takahiro UEDA, Kyoto-shi (JP); Yusaku YAMASAKI, Kyoto-shi (JP)

(73) Assignee: OMRON Corporation, KYOTO (JP)

(21) Appl. No.: 18/826,192

(22) Filed: Sep. 6, 2024

(30) Foreign Application Priority Data
Oct. 20, 2023 (JP) 2023-181400

(51) Int. Cl. H01H 9/06; B25F 5/02

(52) U.S. Cl. CPC H01H 9/06; B25F 5/02; H01H 2009/065

(57) ABSTRACT

A trigger switch TS includes a trigger 1 receiving a press through an operation of an operator to be movable to a deepest position in a press direction. The trigger includes: a base shaft member 11, to which a trigger cap 10 is removably attached; and a limiting member 14, supported by the base shaft member to be operable, and able to limit a movement of the trigger. In the trigger where the trigger cap 10 is attached to the base shaft member, if a first press is received, the movement is limited at a limited position not arriving at the deepest position through the limiting member in a limited state. With removal of the received first press, the limiting member transitions to from the limited state to an unlimited state and, if a second press is received following the removal, it is possible to move to the deepest position.

### CROSS-REFERENCE TO RELATED APPLICATION

This application claims the priority benefit of Japan application serial no. 2023-181400, filed on Oct. 20, 2023. The entirety of the above-mentioned patent application is hereby incorporated by reference herein and made a part of this specification.

### BACKGROUND

### Technical Field

The invention relates to a trigger switch including a trigger that receives a press operation.

### Description of Related Art

A trigger switch used in the operation of an electric tool includes a trigger that receives a press operation of the operator (see, for example, Patent Document 1). The operator places a finger at the trigger and pull (push) the trigger, thereby activating the trigger switch and causing the electric tool to operate. The trigger of the trigger switch has, for example, a trigger cap and a base shaft member (plunger). The operator's finger is placed on the trigger cap, and the base shaft member supports the trigger cap. In addition, to attain the operation feeling and appearance that fit the operator's preference and prevent unauthorized use, attention has been focused on a trigger switch in which the trigger cap can be attached to and removed with respect to the base shaft member.

### PRIOR ART DOCUMENT(S)

### Patent Document(s)

[Patent Document 1] Japanese Laid-open No. 2012-206248

In the trigger switch in which the trigger cap can be attached/removed, for example, in order to prevent an erroneous operation in the case where the trigger cap is attached to the base shaft member, for example, measures such as cutting off the main power supply are essential, and various and multiple measures have been proposed.

The invention provides a trigger switch with high safety, such as preventing an erroneous operation.

### SUMMARY

An aspect of the invention provides a trigger switch. The trigger switch includes: a trigger, able to receive a press through an operation of an operator to move to a deepest position in a press direction; and a housing, supporting the trigger to be movable. The trigger includes: a trigger cap, having a finger placement part where a finger of the operator is placed; a base shaft member, to which the trigger cap is removably attached; and a limiting member, supported by the base shaft member to be operable, and able to limit a movement of the trigger. The base shaft member has: an attachment part, to which the trigger cap is attached; and a shaft part, where an end side of the shaft part supports the attachment part, and an other end side of the shaft part is inserted through the housing. In a case where the trigger cap is removed, with the limiting member in a limited state, the movement of the trigger is limited at a limited position not arriving at the deepest position, and in a case where the trigger cap is attached, the limiting member is able to transition between the limited state and an unlimited state in which a limitation on the movement of the trigger is removed.

### BRIEF DESCRIPTION OF THE DRAWINGS

FIG. 1 is a schematic perspective view illustrating an example of the appearance of an electric device according to the disclosure.

FIG. 2 is a schematic perspective view illustrating an example of the appearance of a trigger switch according to the disclosure.

FIG. 3 is a schematic perspective view illustrating an example of the appearance of a trigger switch according to the disclosure.

FIG. 4 is a schematic exploded perspective view illustrating an example of the trigger switch according to the disclosure.

FIG. 5 is a schematic perspective view illustrating an example of a trigger provided in the trigger switch of the disclosure.

FIG. 6 is a schematic perspective view illustrating an example of a trigger cap of the trigger provided in the trigger switch of the disclosure.

FIG. 7 is a schematic perspective view illustrating an example of a base shaft member provided in the trigger switch of the disclosure.

FIG. 8 is a schematic perspective view illustrating an example of the base shaft member provided in the trigger switch of the disclosure.

FIG. 9 is a schematic perspective view illustrating an example of a limiting member provided in the trigger switch of the disclosure.

FIG. 10 is a schematic perspective view illustrating an example of the limiting member provided in the trigger switch of the disclosure.

FIG. 11 is a schematic perspective view illustrating an example of a detachment prevention member provided in the trigger switch of the disclosure.

FIG. 12 is a schematic cross-sectional view illustrating an example of a front part of the trigger switch of the disclosure.

FIG. 13 is a schematic cross-sectional view illustrating an example of the front part of the trigger switch of the disclosure.

FIG. 14 is a schematic cross-sectional view illustrating an example of the front part of the trigger switch of the disclosure.

FIG. 15 is a schematic cross-sectional view illustrating an example of the front part of the trigger switch of the disclosure.

FIG. 16 is a schematic cross-sectional view illustrating an example of the front part of the trigger switch of the disclosure.

FIG. 17 is a schematic cross-sectional view illustrating an example of the front part of the trigger switch of the disclosure.

### DESCRIPTION OF THE EMBODIMENTS

An aspect of the invention provides a trigger switch. The trigger switch includes: a trigger, able to receive a press through an operation of an operator to move to a deepest position in a press direction; and a housing, supporting the trigger to be movable. The trigger includes: a trigger cap, having a finger placement part where a finger of the operator is placed; a base shaft member, to which the trigger cap is removably attached; and a limiting member, supported by the base shaft member to be operable, and able to limit a movement of the trigger. The base shaft member has: an attachment part, to which the trigger cap is attached; and a shaft part, where an end side of the shaft part supports the attachment part, and an other end side of the shaft part is inserted through the housing. In a case where the trigger cap is removed, with the limiting member in a limited state, the movement of the trigger is limited at a limited position not arriving at the deepest position, and in a case where the trigger cap is attached, the limiting member is able to transition between the limited state and an unlimited state in which a limitation on the movement of the trigger is removed.

In addition, in the trigger switch, in the case where the first press is received, in the trigger in which the trigger cap is attached to the base shaft member, the movement is limited by the limiting member in the limited state, in a case where the received first press is released, the limiting member transitions from the limited state in which the movement of the trigger is limited to the unlimited state, and in a case where a second press is received after the first press is released, since the limiting member is in the unlimited state, the trigger is able to move to the deepest position.

In addition, in the trigger switch, in the housing, a locking part engaged with the limiting member, and the limiting member has an engagement part engaged with the housing. The limiting member performs an operation of transitioning between the limited state, with respect to the movement of the trigger through pressing, in which the engagement part is engaged with the locking part of the housing and the unlimited state, with respect to the movement of the trigger through pressing, in which the engagement part is not engaged with the locking part.

In addition, in the trigger switch, the limiting member is supported by the base shaft member to be movable between a first position where the limiting member is in the limited state and a second position where the limiting member is able to transition between the limited state and the unlimited state. In the case where the first press is received, the limiting member in the limited state at the first position moves from the first position to the second position while maintaining the limited state, and in the case where the first press is released, the limiting member at the second position transitions from the limited state to the unlimited state.

In addition, in the trigger switch, the trigger switch includes a biasing member that biases the limiting member, the trigger cap has an abutment part abutting against the limiting member. In the case where the first press is received, with the trigger cap pressing the limiting member by using the abutment part, the limiting member, in a state of being engaged with the locking part, resists biasing of the biasing member to move from the first position to the second position. In the case where the first press is released, with the limiting member performing a swing operation using a portion abutting against the abutment part of the trigger cap as a fulcrum through the biasing of the biasing member, engagement with the locking part is removed to transition from the limited state to the unlimited state.

In addition, in the trigger switch, the limiting member has: a swing part, serving as a swing shaft, the limiting member is supported by the base shaft member to be able to perform the swing operation with the swing part as the swing shaft, and, from the base shaft member, the limiting member is biased by the biasing member through removal of the trigger cap and moves to the first position, and is biased by the biasing member through swinging the swing part as the swing shaft at the first position to become the limited state.

The trigger switch according to the disclosure is able to increase the safety, such as preventing an erroneous operation, etc.

The trigger switch according to the disclosure is able to increase the safety, such as preventing an erroneous operation, etc.

In the following, the embodiments of the invention will be described with reference to the drawings.

### Application Example

A trigger switch according to the disclosure is applicable to various electric devices, including electric tools such as an electric drill, an electric driver, an electric wrench, an electric grinder, etc., including a driving part, such as a motor. In the following, an electric device PT and a trigger switch TS attached to the electric device PT shown in the drawings are described with reference to the drawings.

### Electric Device PT

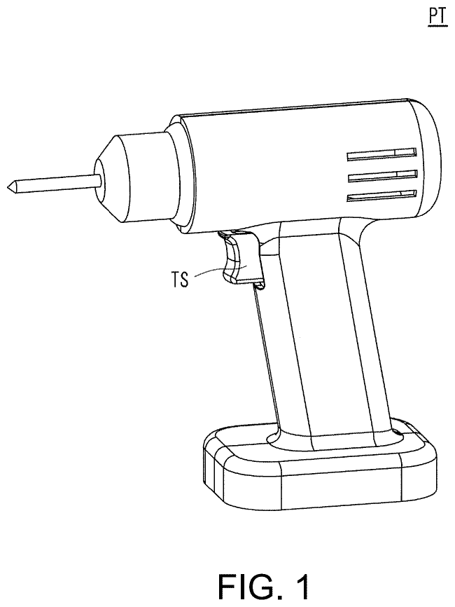

FIG. 1 is a schematic perspective view illustrating an example of the appearance of the electric device PT according to the disclosure. The electric device PT of the disclosure can be applied to an electric tool, such as an electric drill, an electric driver, an electric wrench, an electric grinder, etc., and can be further applied to various devices, such as a water gun, a paint gun, a model gun, etc., provided with the trigger switch TS. The electric device PT shown in FIG. 1 forms a shape in which a hand-held portion is attached to a main portion in a substantially cylindrical shape that accommodates a driving part (not shown), such as an electric motor. The trigger switch TS used in the operation of the electric device PT is attached to the hand-held portion. In the following description, as shown in the figure, the direction of the main portion in the substantially cylindrical shape is described as “upper”, and the direction of the hand-held portion is described as “lower”. In addition, the direction in which a rotary tool, such as a drill, is attached is described as “front”, and the direction in which the trigger switch is pressed is described as “rear”. That is, in the trigger switch TS built in the electric device PT, the direction from front to rear is the press direction in the press operation. Such expressions are merely defined for the ease of description, and shall not be considered as limiting the directions of using the electric device PT and the trigger switch TS.

### Trigger switch TS

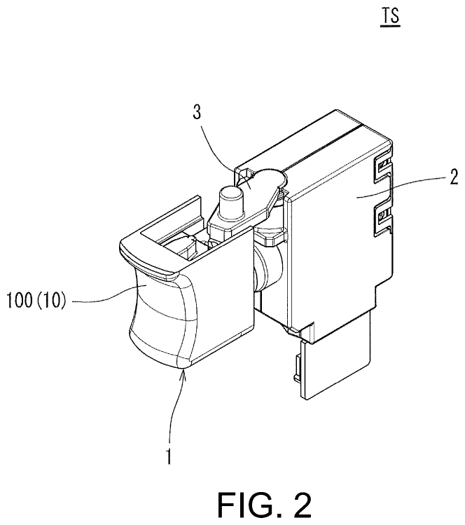

Then, the trigger switch TS included in the electric device PT is described. FIG. 2 is a schematic perspective view illustrating an example of the appearance of the trigger switch TS according to the disclosure. The trigger switch TS includes a trigger 1, a housing 2, and a switch lever 3, etc. The trigger 1 is a component receiving the press operation of the operator, and is built in the electric device PT in an exposed state, so as to be operable. The trigger 1 is able to move from a release position in a state in which a press operation is not received to a deepest position in the press direction by receiving the press operation. The trigger 1 includes a trigger cap 10 having a finger placement part 100 where the finger of the operator is placed. The finger placement part 100 of the trigger cap 10 is curved in a concave shape for the ease of finger placement. The housing 2 accommodates various components, and is built inside the electric device PT. The switch lever 3 is a component for switching the setting of an operation direction, an operation mode, etc.

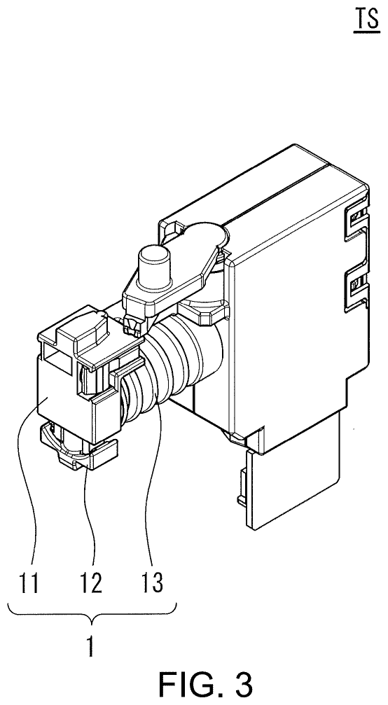

FIG. 3 is a schematic perspective view illustrating an example of the appearance of the trigger switch TS according to the disclosure. The trigger cap 10 included in the trigger 1 is able to be attached and removed. FIG. 3 illustrates a state in which the trigger cap 10 is removed from the trigger 1. The trigger 1 further includes a base shaft member 11, a detachment prevention member 12, and a cover member 13. The base shaft member 11 supports the trigger cap 10. The detachment prevention member 12 prevents the trigger cap 10 attached to the base shaft member 11 from being detached. The cover member 13 covers the exposed portion of the base shaft member 11.

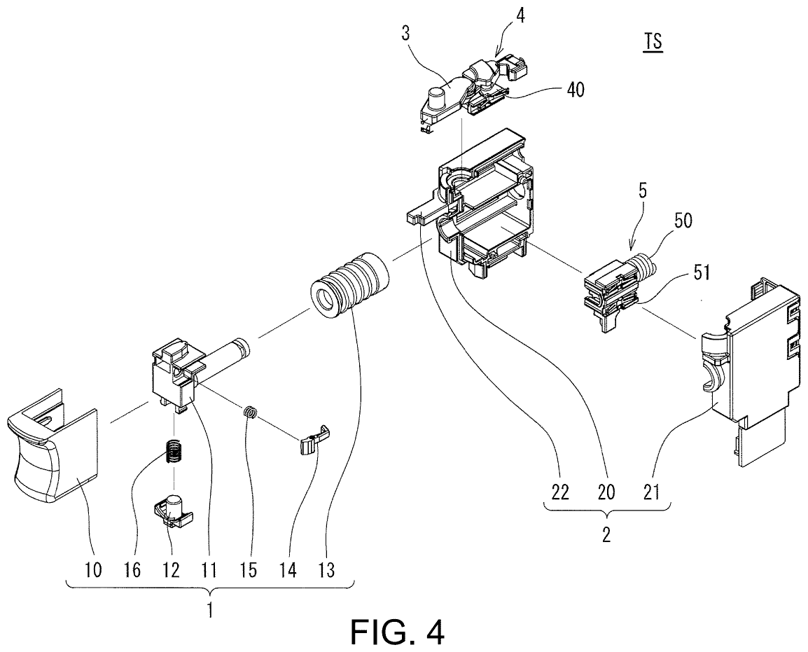

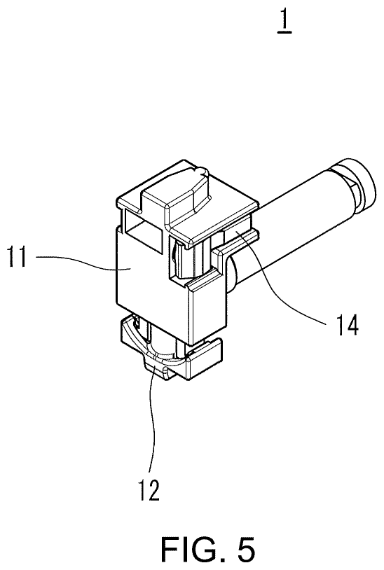

FIG. 4 is a schematic exploded perspective view illustrating an example of the trigger switch TS according to the disclosure. FIG. 5 is a schematic perspective view illustrating an example of the trigger 1 provided in the trigger switch TS of the disclosure. FIG. 5 illustrates the trigger 1 in the state in which the trigger cap 10 and the cove member 13 are removed from a front left-oblique top perspective. The trigger switch TS includes the trigger 1, the housing 2, and the switch lever 3, etc., and further includes mechanisms, such as a switch mechanism 4, an opening-closing mechanism 5. The trigger 1 has components such as the trigger cap 10, the base shaft member 11, the detachment prevention member 12, and the cover member 13, and further includes components such as a limiting member 14, a first biasing member 15, a second biasing member 16, etc. FIG. 5 is a view in which the position relationship among the base shaft member 11, the detachment prevention member 12, and the limiting member 14 in the trigger 1 can be visually recognized.

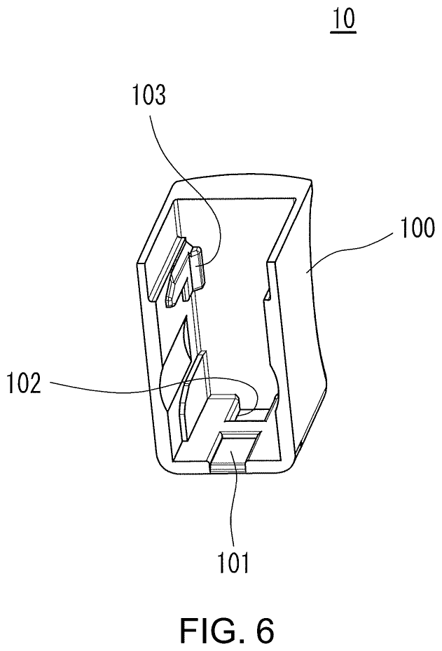

FIG. 6 is a schematic perspective view illustrating an example of the trigger cap 10 of the trigger 1 provided in the trigger switch TS of the disclosure. FIG. 6 illustrates the trigger cap 10 from the rear right-oblique top perspective, and is a view in which the structure of the inner side, which is the side of the base shaft member 11, can be visually recognized. The trigger cap 10 is described with reference to FIGS. 4 to 6. The trigger cap 10 is formed in a hollow box shape as a substantially rectangular parallelopiped body, with the upper surface and the rear surface being open. In the trigger cap 10, a step-like stepped part 101 whose height increases in a stepwise manner is formed from the rear end side (the front side in the figure) on the inner bottom surface, and a through hole 102 penetrating through the bottom surface is formed at the front (the deep side) of the stepped part 101. In the case where the trigger cap 10 is attached to the base shaft member 11, the stepped part 101 serves to guide the trigger cap 10 and lift the detachment prevention member 12. In the case where the trigger cap 10 is attached to the base shaft member 11, the detachment prevention member 12 is fit into the through hole 102, and the through hole 102 serves to prevent the trigger cap 10 from being detached. The detachment prevention member 12 fit into the through hole 102 penetrates through the through hole 102 and is exposed from the lower part of the trigger cap 10. In the trigger cap 10, an abutment part 103 abutting against the limiting member 14 is formed from the inner wall surface on the left side to the inner wall surface at the front. The abutment part 103 is formed at the corner between the inner wall surface on the left side and the inner wall surface at the front to protrude toward the inner side in a fan shape when viewed in a plan view, and abuts against the limiting member 14 at the time when the trigger cap 10 is to be attached to the base shaft member 11 and in the state in which the trigger cap 10 is attached to the base shaft member 11.

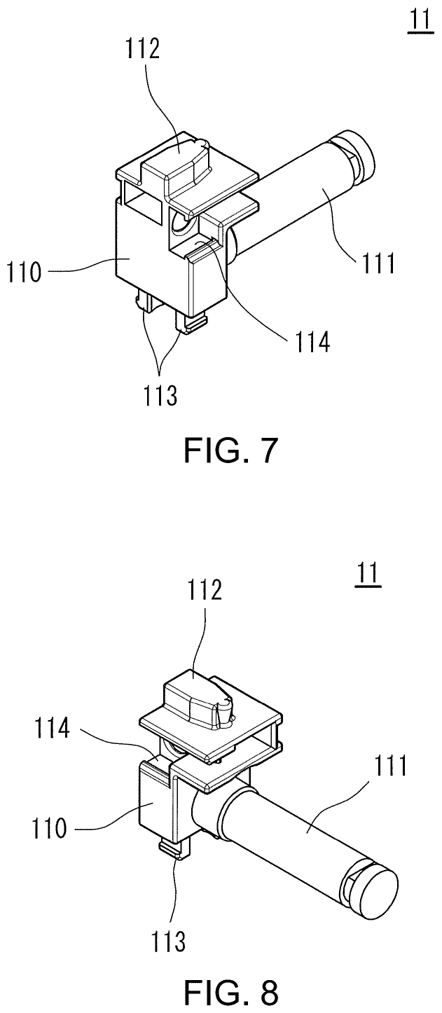

FIGS. 7 and 8 are schematic perspective views illustrating an example of the base shaft member 11 provided in the trigger switch TS of the disclosure. FIG. 7 illustrates the base shaft member 11 from the front left-oblique top perspective, and FIG. 8 illustrates the base shaft member 11 from the rear left-oblique top perspective. The base shaft member 11 is described with reference to FIGS. 4, 5, 7, and 8. The base shaft member 11 is a plunger having an attachment part 110 and a shaft part 111. The trigger cap 10 is attached to the attachment part 110, and the shaft part 111 extends rearward from the attachment part 110. In the shaft part 111, the front end (an end side) supports the attachment part 110, and the rear part (the other end side) is inserted into the housing 2. The opening-closing mechanism 5 is attached to the rear end of the shaft part 111 located in the housing 2. The attachment part 110 located at the front is formed in a substantially rectangular parallelopiped body. In the attachment part 110, a lever locking part 112 is formed on the upper surface. The lever locking part 112 is in a substantially pentagonal columnar shape and able to be engaged with the switch lever 3 to lock the switch lever 3. In the attachment part 110, a pair of left and right guide pieces 113 are formed on the lower surface to extend downward. The guide piece 113 guides the upper-lower movement of the detachment prevention member 12. In the attachment part 110, a support part 114 is formed at the left side part. The support part 114 supports the limiting member 14 to be operable. The support part 114 is formed as a concave part in a substantially rectangular parallelopiped shape at the left side part of the attachment part 110. The front surface and the left side surface of the support part 114 formed as the concave part are open. The inner bottom surface and the inner top surface of the support part 114 formed as a concave part are formed as surfaces substantially parallel to each other. The support part 114 supports the limiting member 14 so as to sandwich the limiting member 14 in the upper-lower direction by using the inner bottom surface and the inner top surface. While supported by the inner bottom surface and the inner top surface of the support part 114, the limiting member 14 is not fixed, and is able to perform operations such as a swing operation, a move operation, etc. The rear of the support part 114 is formed in a shape that guides but does not limit the operation of the limiting member 14 supported by the support part 114. In the support part 114, a concave part in a substantially circular shape against which the first biasing member 15 abuts is formed on an inner wall surface opposite to the limiting member 14.

The cover member 13 is described with reference to FIG. 4. The cover member 13 is a flexible bellows that covers the shaft part 111 of the base shaft member 11. The cover member 13 covers a portion exposed to the outside of the housing 2 in the shaft part 111 of the base shaft member 11. In the cover member 13, the front end abuts against the attachment part 110 of the base shaft member 11, and the rear end abuts against the front surface of the housing 2.

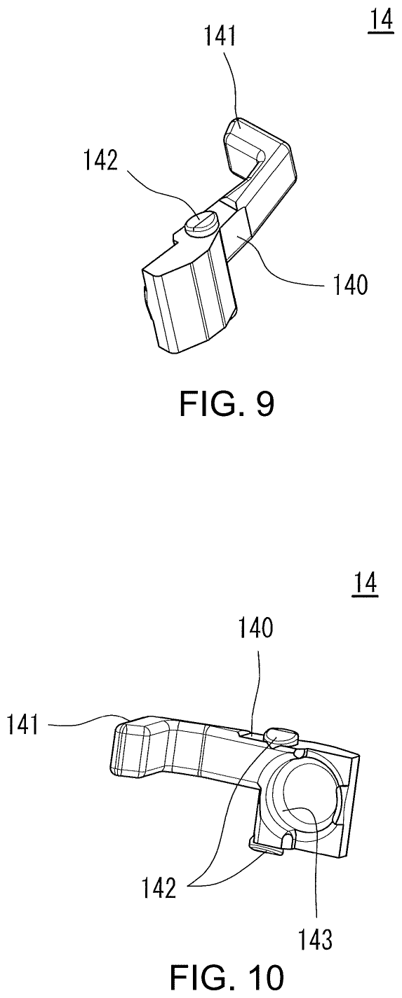

FIGS. 9 and 10 are schematic perspective views illustrating an example of the limiting member 14 provided in the trigger switch TS of the disclosure. FIG. 9 illustrates the limiting member 14 from the front left-oblique top perspective, and FIG. 10 illustrates the limiting member 14 from the front right-oblique top perspective. The limiting member 14 is described with reference to FIGS. 4, 5, 9, and 10. In the limiting member 14, the rear end of an extension part 140 extending substantially in the front-rear direction is formed in a hook-shape bent leftward as an engagement part 141. The engagement part 141 is bent at a slight obtuse angle with respect to the extending direction of the extension part 140. The engagement part 141 is engaged with the housing 2 in accordance with the operating status of the limiting part 14. In the extension part 140, at a position of about one-third from the front end, a swing part 142 in a substantially cylindrical shape protruding in the upper-lower direction is formed. The swing part 142 is sandwiched by the inner bottom surface and the inner top surface of the support part 114 of the base shaft member 11 to serve as a swing shaft, and the swing part 142 performs a swing operation as the swing shaft. While the swing part 142 serves as a swing shaft, the swing part 142 is not fixed in the support part 114 of the base shaft member 11. In the state in which the swing part 142 is sandwiched between the inner bottom surface and the inner top surface, the limiting member 14, for example, performs a move operation in the left-right direction intersecting the press direction. In the extension part 140 of the limiting member 14, the left side surface in the vicinity of the front end is inclined in a stepwise manner. In the limiting member 14, a fitting concave part 143 in a substantially circular shape is formed from the vicinity of the front end on the right side surface to the swing part 142. An end of the first biasing member 15 is fit into the fitting concave part 143. The first biasing member 15 is formed by using a compression coil spring, for example. An end side of the first biasing member 15 is fit into the fitting concave part 143 of the limiting member 14, the other end side abuts against the the concave part of the inner wall surface inside the support part 114 of the base shaft member 11, and the first biasing member 15 biases the limiting member 14 leftward by using the end side.

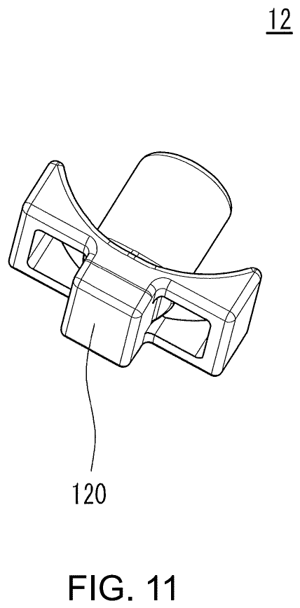

FIG. 11 is a schematic perspective view illustrating an example of the detachment prevention member 12 provided in the trigger switch TS of the disclosure. The detachment prevention member 12 is described with reference to FIGS. 4 to 8 and 11. The detachment prevention member 12 has, at the lower part, a button part 120 having a square columnar shape and protruding downward. The detachment prevention member 12 is guided by the guide pieces 113 of the base shaft member 11 to be upper-lower movably attached to the lower part of the attachment part 110 of the base shaft member 11. In the detachment prevention member 12, the upper part is formed to be shaft-like, and the second biasing member 16 is wound thereupon. In the second biasing member 16, the lower end abuts against the detachment prevention member 12, and the upper end abuts against the lower surface of the attachment part 110 of the base shaft member 11. The second biasing member 16 is formed by using a compression coil spring, for example, and biases the detachment prevention member 12 downward. In the case where the trigger cap 10 is attached to the attachment part 110 of the base shaft member 11, the button part 120 of the detachment prevention member 12 is fit into the through hole 102 of the trigger cap 10, and the button part 120 and the through hole 102 are engaged to prevent the detachment of the trigger cap 10. In addition, in the case where the trigger cap 10 attached to the attachment part 110 of the base shaft member 11 is removed, by pressing the button part 120 exposed from the through hole 102 of the trigger cap 10 upward against the biasing force of the second biasing part, the engagement between the button part 120 and the through hole 102 is removed, and the trigger cap 10 becomes removable.

The housing 2 is described with reference to FIGS. 2 to 4. The housing 2 is a hollow box in a substantially rectangular parallelopiped shape, and is formed by assembling a right half 20 and a left half 21. The housing 2 accommodates therein various components, such as the rear part of the shaft part 111 of the base shaft member 11, various circuits, a portion of the switch mechanism 4, the opening-closing mechanism 5. An opening in a substantially circular shape is provided to be open on the front surface of the housing 2, and the shaft part 111 of the base shaft member 11 penetrates through the opening. The switch lever 3 penetrates through and is attached to the upper surface of the housing 2. A substrate (not shown) on which various circuits are disposed is disposed on the inner side of the left half 21 of the housing 2, and the lower end of the substrate is exposed from the lower part of the housing 2 and serves as a terminal forming a driving part and a circuit accommodated in the body of the electric device PT. In the housing 2, a plate-shaped locking part 22 extending forward from the front surface of the right half 20 is formed. The locking part 22 is engaged with the engagement part 141 of the limiting member 14 to limit the movement of the trigger switch TS.

The switch mechanism 4 is described with reference to FIG. 4. The switch mechanism 4 is linked with the operation of the switch lever 3 and has a switch contact brush 40 that moves in the front-rear direction. With the switch contact brush 40 moving in the front-rear direction, a switch circuit formed by the switch contact brush 40 and a circuit on the substrate disposed on the inner side of the left half 21 of the housing 2 switches, and the setting switches. The switch lever 3 operating the switch mechanism 4 can be swung in the left-right direction, and, in the case of being located at the middle part of the swing range, the switch lever 3 is engaged with the lever locking part 112 of the base shaft member 11 and prevents the trigger 1 from being pressed.

The opening-closing mechanism 5 is described with reference to FIG. 4. The opening-closing mechanism 5 is attached to the rear end of the shaft part 111 of the base shaft member 11, and moves together with the movement of the trigger 1. A third biasing member 50 using a compression coil spring is disposed at the rear part of the opening-closing mechanism 5 and biases the trigger 1 forward via the opening-closing mechanism 5. The opening-closing mechanism 5 has an opening-closing contact brush on the left side surface. The opening-closing contact brush 51 forms an opening-closing circuit with a circuit on the substrate disposed on the inner side of the left half 21 of the housing 2. With the opening-closing mechanism 5 moving in the front-rear direction, the opening-closing circuit switches, and, for example, control is exerted to drive, stop, or change the speed of a power unit.

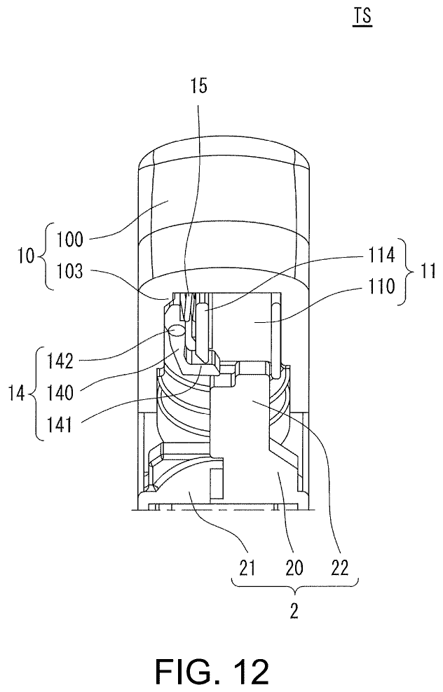

Then, the operation of the trigger switch TS configured as the above is described. FIG. 12 is a schematic cross-sectional view illustrating an example of the front part of the trigger switch TS of the disclosure. FIG. 12 illustrates a horizontal cross-sectional surface of the front part of the trigger switch TS from a top perspective. The top in the view is shown as the front of the trigger switch TS. In the state in which the trigger cap is removed before the state of FIG. 12, the limiting member 14 is biased by the first biasing part 15 to be located at a first position on the left end side in the support part 114. FIG. 12 illustrates a state in which the removed trigger cap 10 is placed over the attachment part 110 of the base shaft member 11 from such state. In FIG. 12, although the trigger cap 10 is placed over the front end of the attachment part 110 of the base shaft member 11, the trigger cap 10 is not fixed. In FIG. 12, for the limiting member 142 located at the first position, the first biasing member 15 mainly biases the limiting member 14 between the front end and the swing part 142. Therefore, the biasing member 14 swing to rotate leftward (in the counter-clockwise direction), and the engagement part 141 at the rear end is located on the right side.

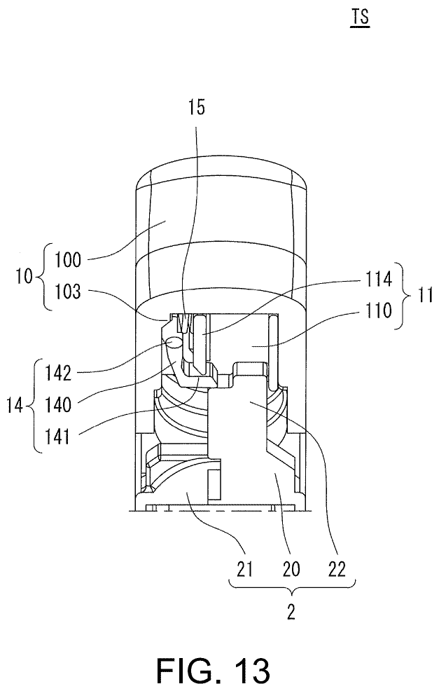

FIG. 13 is a schematic cross-sectional view illustrating an example of the front part of the trigger switch TS of the disclosure. FIG. 13 illustrates the state in which the trigger cap 10 is pressed rearward and becomes attached from the state shown in FIG. 12. In the state shown in FIG. 13, the button 120 of the detachment prevention member 12 is fit into the through hole 102 of the trigger cap 10, and the trigger cap 10 is fixed so as not to be detached. In the state shown in FIG. 13, the limiting member 14 is located at the first position inside the support part 114 of the base shaft member 11 and biased by the first first biasing member 15, and the engagement part 141 at the rear end is located at a position engaged with the locking part 22 of the housing 2. In the case where the engagement part 141 is at the engagement position with the locking part 22, even if the trigger 1 receives a press operation, the trigger 1 cannot move to the deepest position, and the movement is limited at a limited position not arriving at the deepest position. That is, in the state shown in FIG. 13, the trigger 1 is in a limited state in which the movement is limited at the limited position. Accordingly, in a process of attaching the trigger cap 10 to the base shaft member 11, even if the trigger cap 10 is fiercely pressed toward the press direction (rearward), the movement of the trigger 1 is limited at the limited position and and the trigger 1 does not arrive at the deepest position. Therefore, even if the power supply and various other safety functions are not functioning, the driving part does not perform driving through the pressing of the trigger 1, and a safe state is maintained.

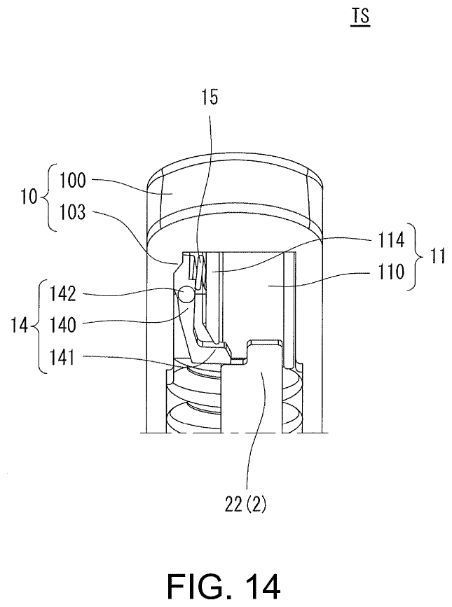

FIG. 14 is a schematic cross-sectional view illustrating an example of the front part of the trigger switch TS of the disclosure. FIG. 14 takes a different horizontal cross-section lower than that of FIG. 13 in the state of FIG. 13 and illustrates from a top perspective. In the state shown in FIG. 14, the left side surface in the vicinity of the front end of the limiting member 14 abuts against the abutment part 103 of the trigger cap 10.

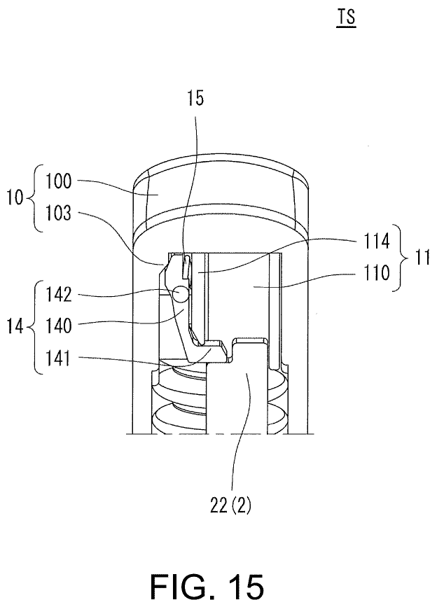

FIG. 15 is a schematic cross-sectional view illustrating an example of the front part of the trigger switch TS of the disclosure. FIG. 15 illustrates a state in which a press operation pressing the trigger 1 toward the press direction from the state shown in FIG. 14 is received. In the application, the pressing of the trigger 1 through an initial press operation since the end of the attachment of the trigger cap 10 is referred to as a first press, and the pressing of the trigger 1 through a second or subsequent press operation is referred to as a second press. That is, FIG. 15 illustrates the state of receiving the first press from the state shown in FIG. 14. In the case of receiving the first press operation, the engagement part 141 of the limiting member 14 is a state of being engaged with the locking part 22 of the housing 2 and unable to move in the press direction (rearward), so the abutment part 103 of the trigger cap 10 presses the limiting member 14 leftward while abutting against the limiting member 14. The limiting member 14 receiving the leftward pressing from the abutment part 103 resists the biasing force of the first biasing member 15 and moves from the first position to the second position while maintaining the limited state in which the engagement part 141 and the locking part 22 are engaged. The movement from the first position to the second position is a movement in a direction from left to right that intersects with the press direction. Within the movement range of the limiting member 14, the first position is a position on the left end side, and, in the case of being located at the first position, the limiting member 14 is in the limited state of being engaged with the locking part 22. Within the movement range of the limiting member 14, the second position is a position on the right end side, and, in the case of being located at the second position, the limiting member 14 operates to transition between the limited state and an unlimited state. FIG. 15 illustrates a state in which the limiting member is moved to the second position. In the state in which the limiting member 14 moves to the second position as shown in FIG. 15, the engagement part 141 of the limiting member 14 maintains the engagement with the locking part 22 of the housing 2, so, for the first press, the movement of the trigger 1 is limited at the limited position. Accordingly, in the case of receiving the first press, the movement of the trigger 1 is limited at the limited position and does not arrive at the deepest position. That is, the driving part does not perform driving through the press of the trigger 1, and the safe state is maintained.

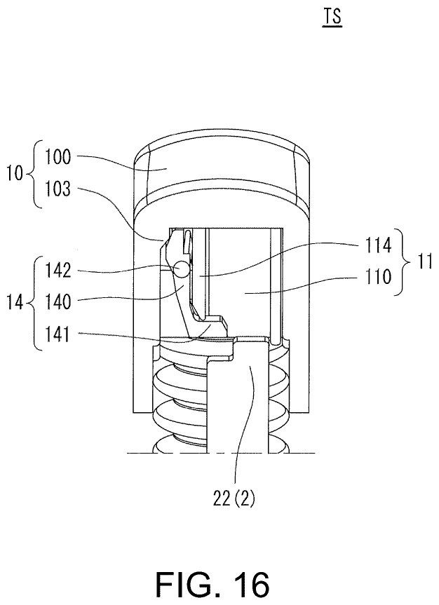

FIG. 16 is a schematic cross-sectional view illustrating an example of the front part of

the trigger switch TS of the disclosure. FIG. 16 illustrates a state immediately after the first press with respect to the trigger 1 is released and the trigger 1 is biased by the third biasing part 50 to move to the release position at the front from the state shown in FIG. 15. In the state shown in FIG. 16, the limiting member 14 is located at the second position and abuts against the abutment part 103 of the trigger cap 10, and the trigger 1 is in the limited state in which the movement is limited at the limited position. Through the movement of the limiting member 14 from the first position to the second position, the first biasing member 15 becomes compressed. Then, the first press shown in FIG. 16 is released, and the trigger 1 moves to the released position. Accordingly, the engagement between the engagement part 141 of the limiting member 14 and the locking part 22 of the housing 2 is removed.

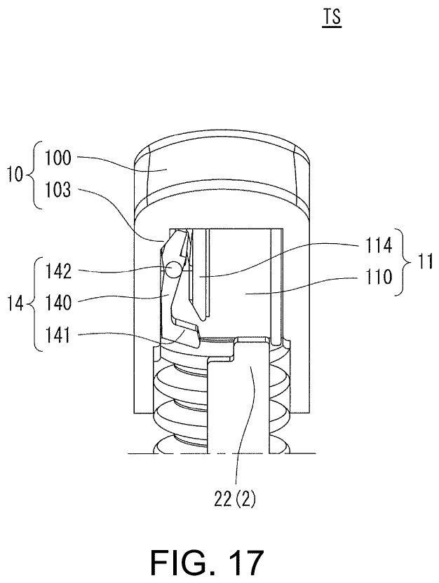

FIG. 17 is a schematic cross-sectional view illustrating an example of the front part of the trigger switch TS of the disclosure. FIG. 17 illustrates a state in which the limiting member 14 operates from the state shown in FIG. 16. By removing the engagement between the engagement part 141 of the limiting member 14 and the locking part 22 of the housing 2, through the biasing of the first biasing member 15, the limiting member 14 performs a swing operation toward the right (in the clockwise direction) in the figure by using a portion abutting against the abutment part 103 of the trigger cap 10 as the fulcrum. As shown in FIG. 17, through the swing operation, the engagement part 141 of the limiting member 14 moves toward the side of the left half 21 of the housing 2 and transitions from the limited state to the unlimited state. In the state shown in FIG. 17, in the operation of pressing the trigger 1, that is, in the case of receiving the second press, the engagement part 141 of the limiting member 14 is located at a position not engaged with the locking part 22 of the housing 2, so the trigger 1 can be pressed to the deepest position. In the case of the second or subsequent press, instead of an erroneous operation, it is likely that the operator consciously performs the operation.

According to the above, the trigger switch TS of the disclosure prevents an erroneous operation at the time of attaching the trigger cap 10, whereas the trigger cap 10 can be attached/removed. Moreover, in the trigger switch TS of the disclosure, after the trigger cap 10 is attached, the first press that is the first time is limited to ensure the safety, while the second press after the first press is released is possible. In this way, the trigger switch TS of the disclosure is able to secure safety and operability, etc., and achieve an excellent effect.

The invention is not limited to the above embodiments, and can be embodied in various other forms. Therefore, the embodiments are merely illustrative in all respects and should not be construed as limitations. The technical scope of the invention is defined by the claims and is not restricted in any way by the text of the specification. Furthermore, all modifications and variations within the scope of the claims are within the scope of the invention.

For example, in the embodiments, the limiting member 14 is shown in a mode of being able to perform the swing operation by using the swing part 142 as the swing shaft and the movement operation between the first position and the second position. However, the invention is not limited thereto. It is possible to develop various configurations, such as a configuration without the swing part 142.

That is, the trigger switch TS disclosed in the application can be deployed in various modes according to the following.

### Appendix 1

A trigger switch includes: a trigger, able to receive a press through an operation of an operator to move to a deepest position in a press direction; and a housing, supporting the trigger to be movable. The trigger includes: a trigger cap, having a finger placement part where a finger of the operator is placed; a base shaft member, to which the trigger cap is removably attached; and a limiting member, supported by the base shaft member to be operable, and able to limit a movement of the trigger. The base shaft member has: an attachment part, to which the trigger cap is attached; and a shaft part, where an end side of the shaft part supports the attachment part, and an other end side of the shaft part is inserted through the housing. In a case where the trigger cap is removed, with the limiting member in a limited state, the movement of the trigger is limited at a limited position not arriving at the deepest position, and in a case where the trigger cap is attached, the limiting member is able to transition between the limited state and an unlimited state in which a limitation on the movement of the trigger is removed.

### Appendix 2

In the trigger switch according to Appendix 1, in the case where the first press is received, in the trigger in which the trigger cap is attached to the base shaft member, the movement is limited by the limiting member in the limited state. In a case where the received first press is released, the limiting member transitions from the limited state in which the movement of the trigger is limited to the unlimited state, and in a case where a second press is received after the first press is released, since the limiting member is in the unlimited state, the trigger is able to move to the deepest position.

### Appendix 3

In the trigger switch according to Appendix 2,
the housing has: a locking part engaged with the limiting member, the limiting member has: an engagement part engaged with the housing, and the limiting member performs an operation of transitioning between the limited state, with respect to the movement of the trigger through pressing, in which the engagement part is engaged with the locking part of the housing and the unlimited state, with respect to the movement of the trigger through pressing, in which the engagement part is not engaged with the locking part.

### Appendix 4

In the trigger switch according to Appendix 3, the limiting member is supported by the base shaft member to be movable between a first position where the limiting member is in the limited state and a second position where the limiting member is able to transition between the limited state and the unlimited state. In the case where the first press is received, the limiting member in the limited state at the first position moves from the first position to the second position while maintaining the limited state, and in the case where the first press is released, the limiting member at the second position transitions from the limited state to the unlimited state.

### Appendix 5

In the trigger switch according to Appendix 4, the trigger switch includes a biasing member that biases the limiting member, and the trigger cap has an abutment part abutting against the limiting member. In the case where the first press is received, with the trigger cap pressing the limiting member by using the abutment part, the limiting member, in a state of being engaged with the locking part, resists biasing of the biasing member to move from the first position to the second position, and in the case where the first press is released, with the limiting member performing a swing operation using a portion abutting against the abutment part of the trigger cap as a fulcrum through the biasing of the biasing member, engagement with the locking part is removed to transition from the limited state to the unlimited state.

### Appendix 6

In the trigger switch according to Appendix 5, the limiting member has: a swing part, serving as a swing shaft. The limiting member is supported by the base shaft member to be able to perform the swing operation with the swing part as the swing shaft, and, from the base shaft member, the limiting member is biased by the biasing member through removal of the trigger cap and moves to the first position, and is biased by the biasing member through swinging the swing part as the swing shaft at the first position to become the limited state.

What is claimed is:

1. A trigger switch, comprising: a trigger, receiving a press through an operation of an operator to be movable to a deepest position in a press direction; and a housing, supporting the trigger to be movable,
wherein the trigger comprises:
a trigger cap, having a finger placement part where a finger of the operator is placed;
a base shaft member, to which the trigger cap is removably attached; and
a limiting member, supported by the base shaft member to be operable, and able to limit a movement of the trigger,
the base shaft member has:
an attachment part, to which the trigger cap is attached; and
a shaft part, wherein an end side of the shaft part supports the attachment part, and an other end side of the shaft part is inserted through the housing,
in a case where the trigger cap is removed, with the limiting member in a limited state, the movement of the trigger is limited at a limited position not arriving at the deepest position, and
in a case where the trigger cap is attached, the limiting member is able to transition between the limited state and an unlimited state in which a limitation on the movement of the trigger is removed.

2. The trigger switch as claimed in claim 1, wherein
in a case where a first press is received,
in the trigger in which the trigger cap is attached to the base shaft member, the movement is limited by the limiting member in the limited state,
in a case where the received first press is released, the limiting member transitions from the limited state in which the movement of the trigger is limited to the unlimited state, and
in a case where a second press is received after the first press is released, since the limiting member is in the unlimited state, the trigger is able to move to the deepest position.

3. The trigger switch as claimed in claim 2, wherein
the housing has:
a locking part engaged with the limiting member,
the limiting member has:
an engagement part engaged with the housing, and
the limiting member performs an operation of transitioning between the limited state, with respect to the movement of the trigger through pressing, in which the engagement part is engaged with the locking part of the housing and the unlimited state, with respect to the movement of the trigger through pressing, in which the engagement part is not engaged with the locking part.

4. The trigger switch as claimed in claim 3, wherein the limiting member is supported by the base shaft member to be movable between a first position where the limiting member is in the limited state and a second position where the limiting member is able to transition between the limited state and the unlimited state, in the case where the first press is received, the limiting member in the limited state at the first position moves from the first position to the second position while maintaining the limited state, and
in the case where the first press is released, the limiting member at the second position transitions from the limited state to the unlimited state.

5. The trigger switch as claimed in claim 4, wherein
the trigger switch comprises a biasing member that biases the limiting member,
the trigger cap has an abutment part abutting against the limiting member,
in the case where the first press is received, with the trigger cap pressing the limiting member by using the abutment part, the limiting member, in a state of being engaged with the locking part, resists biasing of the biasing member to move from the first position to the second position, and
in the case where the first press is released,
with the limiting member performing a swing operation using a portion abutting against the abutment part of the trigger cap as a fulcrum through the biasing of the biasing member, engagement with the locking part is removed to transition from the limited state to the unlimited state.

6. The trigger switch as claimed in claim 5, wherein
the limiting member has:
a swing part, serving as a swing shaft,
the limiting member is supported by the base shaft member to be able to perform the swing operation with the swing part as the swing shaft, and
from the base shaft member, the limiting member is biased by the biasing member through removal of the trigger cap and moves to the first position, and is biased by the biasing member through swinging the swing part as the swing shaft at the first position to become the limited state.
